(19) United States
(12) Patent Application Publication
(10) Pub. No.: US 2013/0266409 A1
(43) Pub. Date: Oct. 10, 2013

(54) PORTABLE PAD FOR CONTAINER

(71) Applicant: Russel M. Van Wormer, Elyria, OH (US)

(72) Inventor: Russel M. Van Wormer, Elyria, OH (US)

(21) Appl. No.: 13/835,848

(22) Filed: Mar. 15, 2013

Related U.S. Application Data
(60) Provisional application No. 61/616,511, filed on Mar. 28, 2012.

(51) Int. Cl. B65F 1/14; B65F 3/04

(52) U.S. Cl. CPC B65F 1/141; B65F 3/041
USPC 414/408; 248/346.02

(57) ABSTRACT

A pad includes a pad top surface, a pad bottom surface, and an inset defined in the pad top surface. The inset is sized and shaped for accommodating a can. A depth of the inset relative to the pad top surface is defined for allowing a can bottom surface to be seated in the inset and below the pad top surface. The inset is recessed to a sufficient depth to reduce a probability of the can, when empty, from tipping in winds.

This application claims the benefit of U.S. Provisional Application No. 61/616,511, filed Mar. 28, 2012, which is hereby incorporated by reference.

### BACKGROUND

The present invention relates to pads for containers. It finds particular application in conjunction with pads for trash containers and will be described with particular reference thereto. It will be appreciated, however, that the invention is also amenable to other applications.

Curbside pickup of trash is a convenience many homeowners appreciate. Typically, a homeowner accumulates trash in at least one (1) container (e.g., a trash can) for periodic pickup (e.g., weekly) at the curb by a municipality or private service.

The curbside pickup commonly involves a truck and at least one operator. The operator drives the truck to the curb and then parks the truck near the trash container. If only one operator is present, the operator exits the driving compartment (e.g., truck cab) after parking the truck to manually empty the contents of each of the trash containers into the truck. The operator then replaces the trash container(s) on or near the curb for the homeowner to retrieve at a later time. If more than one operator is present, the second operator may help speed-up the process by emptying the contents from the trash container(s) at different houses as the first operator drives to position the truck near the respective containers at the various houses.

One approach that has been taken to increase the efficiency of curbside trash pickup has been to automate the process of emptying the trash containers into the truck. For example, uniform trash containers are used in conjunction with specially designed trucks. A specially designed truck includes an arm that can grasp, move, and tip the trash container for emptying the contents of the trash container in the truck before replacing the trash container at the curb. Such a system can help speed up the trash collection process while requiring fewer truck operators. For example, a single truck operator may be able to both drive and empty the trash containers in a shorter amount of time, which may result in overall lower costs and increased efficiency.

However, to realize the increased efficiency in systems such as those described above including uniform trash containers and specialized trucks, the trash containers must be properly positioned for the arm of the truck to easily grasp the containers. Therefore, homeowners must comply with procedures regarding proper placement of their trash containers at the curb. Even if the homeowners do position the trash container(s) properly, external factors such as weather conditions (e.g., wind) or automobiles inadvertently bumping and moving the trash containers out of the correct position before the truck arrives to collect the trash from the containers may impact the efficiency of the automated system. More specifically, if the trash container is not properly positioned at the curb when the truck arrives (e.g., if the trash container is not oriented in a way such that the truck arm can easily grasp the container), the operator likely would need to exit the truck and reorient the container for proper placement before returning to the truck cab and proceeding with the automated process. Such extra steps obviously would slow down the trash collection process.

In addition, after the truck arm replaces the emptied trash container near the curb, the emptied, lighter container is more susceptible to be blown over and/or moved by wind. For example, wind may blow the emptied trash containers into the street, thereby creating driving hazards.

The present invention provides a new and improved apparatus which addresses the above-referenced problems.

### SUMMARY

In one embodiment, a pad includes a pad top surface, a pad bottom surface, and an inset defined in the pad top surface. The inset is sized and shaped for accommodating a can. A depth of the inset relative to the pad top surface is defined for allowing a can bottom surface to be seated in the inset and below the pad top surface. The inset is recessed to a sufficient depth to reduce a probability of the can, when empty, from tipping in winds.

### BRIEF DESCRIPTION OF THE DRAWINGS

In the accompanying drawings which are incorporated in and constitute a part of the specification, embodiments of the invention are illustrated, which, together with a general description of the invention given above, and the detailed description given below, serve to exemplify the embodiments of this invention.

FIG. 1 illustrates trash pads including respective trash containers in accordance with one embodiment of an apparatus illustrating principles of the present invention;

FIG. 2 illustrates a schematic representation of a top view of one of the trash pads in accordance with one embodiment of an apparatus illustrating principles of the present invention;

FIG. 3 illustrates a schematic representation of a first side view of one of the trash pads in accordance with one embodiment of an apparatus illustrating principles of the present invention;

FIG. 4 illustrates a schematic representation of a second side view of one of the trash pads in accordance with one embodiment of an apparatus illustrating principles of the present invention;

FIG. 5 illustrates a schematic representation of a perspective view of one of the trash pads in accordance with one embodiment of an apparatus illustrating principles of the present invention;

FIG. 6 illustrates a schematic representation of a top view of a mold in accordance with one embodiment of an apparatus illustrating principles of the present invention;

FIG. 7 illustrates a schematic representation of a first edge of the mold in accordance with one embodiment of an apparatus illustrating principles of the present invention;

FIG. 8 illustrates a schematic representation of a second edge of the mold in accordance with one embodiment of an apparatus illustrating principles of the present invention;

FIG. 9 illustrates a schematic representation of a third edge of the mold in accordance with one embodiment of an apparatus illustrating principles of the present invention;

FIG. 10 illustrates a schematic representation of a fourth edge of the mold in accordance with one embodiment of an apparatus illustrating principles of the present invention;

FIG. 11 illustrates a schematic representation of a bottom view of the mold in accordance with one embodiment of an apparatus illustrating principles of the present invention;

FIG. 12 illustrates a schematic representation of a perspective view of the mold in accordance with one embodiment of an apparatus illustrating principles of the present invention;

FIG. 13 illustrates a schematic representation of a perspective view of the mold in accordance with a second embodiment of an apparatus illustrating principles of the present invention;

FIG. 14 illustrates a schematic representation of a perspective view of stackable molds;

FIG. 15 illustrates a container interacting with an arm of a truck.

### DETAILED DESCRIPTION OF ILLUSTRATED EMBODIMENT

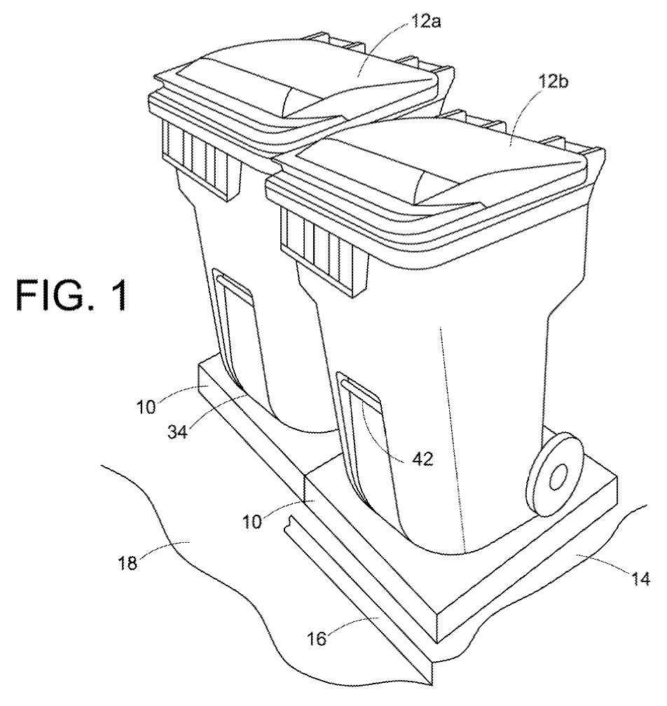

With reference to FIG. 1, two trash pads 10 including two (2) respective trash containers 12a, 12b are illustrated in accordance with one embodiment of the present invention. In the illustrated embodiment, the trash containers 12a, 12b are substantially uniform (e.g., substantially identical) and, therefore, are referred to simply by reference numeral 12. As illustrated, the trash pads 10 are shown on a tree lawn 14 at a curb 16 of a street 18. FIG. 1 illustrates the proper placement of the trash containers 12.

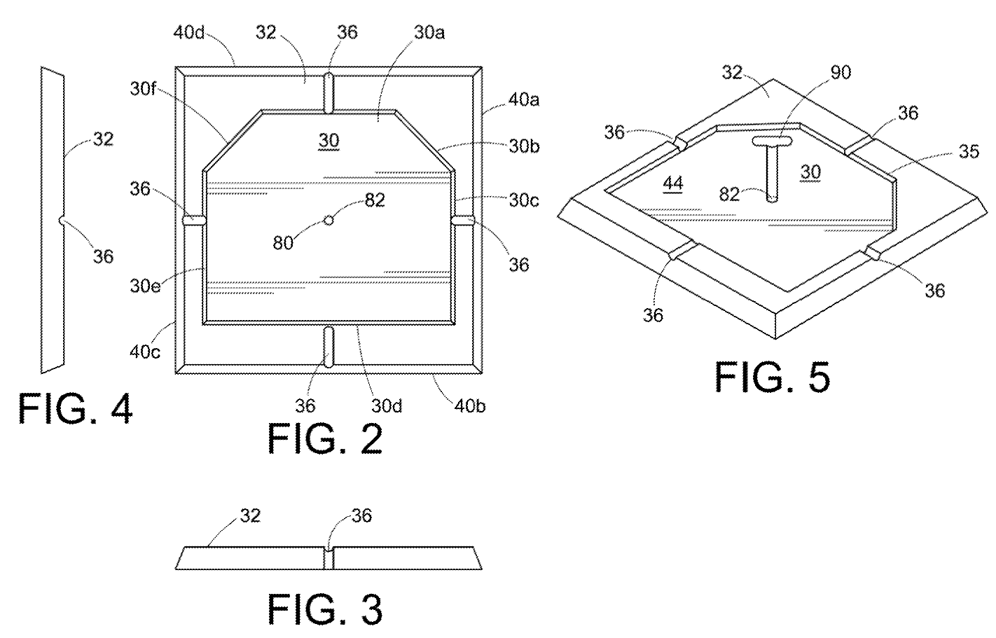

FIGS. 2-5 illustrate various views of one of the trash pads 10 in a first embodiment. For example FIG. 2 illustrates a top view of one of the trash pads 10, FIG. 3 illustrates a first side view of one of the trash pads 10, FIG. 4 illustrates a second side view of one of the trash pads 10, and FIG. 5 illustrates a perspective view of the trash pad 10.

In the embodiment illustrated in FIGS. 1-5, the trash pad 10 is substantially square and includes an inset 30 (e.g., a recessed portion). It is contemplated that the pad 10 is portable. The inset 30 is recessed relative to a top surface 32 of the trash pad 10, and is sized and shaped to accommodate a bottom surface 34 of the trash container 12. For example, in the illustrated embodiment, the inset 30 includes six (6) sides 30a, 30b, 30c, 30d, 30e, 30f. The distance between the sides 30a and 30d is about 23.5″, and the distance between the sides 30c and 30e is about 28.0″. The angle between the sides 30a and 30b is about 135°; the angle between the sides 30b and 30c is about 135°; the angle between the sides 30a and 30f is about 135° ; and the angle between the sides 30e and 30f is about 135°. For example, the inset 30 is recessed between about ¼″ to about 3″ below the top surface 32 of the pad 10. The inset 30 is recessed to a sufficient depth to reduce the probability and/or avoid the container 12 from tipping when the bottom surface 34 of an empty one of the containers 12 (e.g., weighing about 27 lbs.) is positioned in the recess with winds (e.g., cross-winds) up to about 43 mph for containers between about 3′ tall and about 4′ tall. A footprint created by the inset 30 is larger than a footprint at the bottom surface 34 of the container 12. Once the container 12 is properly positioned in the recessed portion 30, cross-winds up to about 43 mph may cause the container 12 to slidably move within the recessed portion 30 (e.g., the bottom surface 34 of the container 12 will slidably move (e.g., slide) across the pad 10 in the recessed portion 30). However, a lip 35 defined at an edge of the recessed portion 30 will engage a side of the container 12 to reduce the probability and/or prevent the container 12 from tipping even when the container 12 is empty. In other words, the recessed portion and/or the lip 35 help contain (e.g., retain) the container 12 so that the container 12 remains upright in the recessed portion 30 and resist the container 12 from tipping, even when empty, in winds (e.g., cross-winds) up to about 43 mph. It is to be understood any dimensions set forth in this application are merely exemplary, and are not intended to limit the scope of the invention. The pad includes a bottom surface, which is on an opposite face of the top surface 32.

The trash pad 10 also includes four (4) channels 36 between the inset 30 and respective edges 40a, 40b, 40c, 40d of the trash pad 10. It is contemplated that the channels 36 permit fluids that accumulate in the inset 30 to drain to an exterior of the trash pad 10.

The recessed insert 30 assists in consistently positioning the trash container 12 on the pad 10 in a particular orientation (as illustrated in FIG. 1). In the correct orientation, an arm of a truck can easily grasp the trash container 12 at, for example, a bar 42 for emptying the contents of the trash container 12 into the truck. After the trash container 12 is emptied, the arm of the truck replaces the trash container 12 back onto the pad 10. The recessed insert 30 provides support for resisting wind from tipping, moving, and/or blowing the emptied container 12. Therefore, the container 12 is more likely to stay on the pad 10 and off any nearby streets and/or lawns where it could pose safety hazards.

It is contemplated that the trash pad 10 material is concrete, plasticized concrete (e.g., precast concrete or plasticized concrete), recycled tires, Quazite, and/or plastic for example, possibly reinforced with steel wire, and is light enough to be portable. Other materials not listed here are also contemplated. A plate 44 made of steel, for example, is contemplated to be in the inset 30. It is expected that the plate 44 will provide additional stability and support for the trash container 12.

As shown in FIG. 1, it is contemplated that the pad 10 is recessed in the ground such that the top surface 32 of the pad 10 is substantially level with a lawn or other surface at the pick-up area. Positioning the top surface 32 of the pad 10 substantially level with the lawn or other surface at the pick-up area helps reduce turf damage and mud from accumulating on the pad 10. The pad 10 (including the inset 30) provides a substantially flat surface on an otherwise unlevel ground (e.g., the lawn) for the trash container 12.

As discussed above, the channels 36 act to drain fluids from the inset 30, which reduces moisture and mud accumulation on the bottom surface 34 of the container 12.

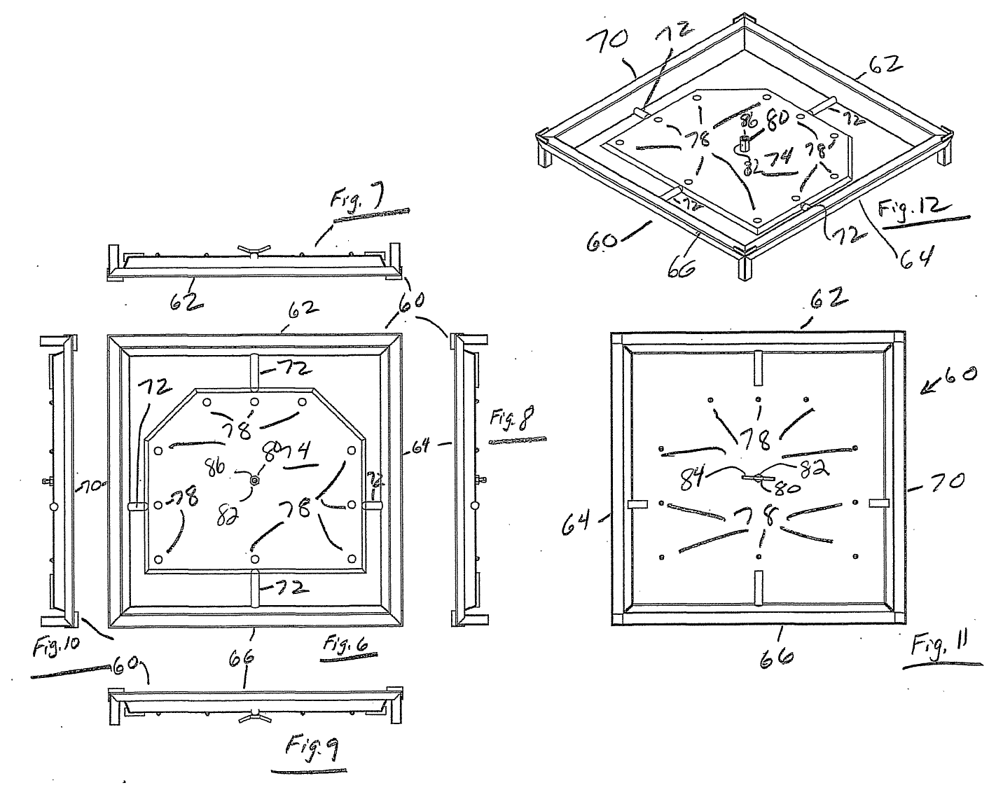

FIGS. 6-12 illustrate schematic representations of a mold 60 for making the pad 10 (see FIGS. 1-5). FIG. 6 illustrates a schematic representation of a top view of the mold 60; FIG. 7 illustrates a schematic representation of a first edge 62 of the mold 60; FIG. 8 illustrates a schematic representation of a second edge 64 of the mold 60; FIG. 9 illustrates a schematic representation of a third edge 66 of the mold 60; FIG. 10 illustrates a schematic representation of a fourth edge 70 of the mold 60; FIG. 11 illustrates a schematic representation of a bottom view of the mold 60; and FIG. 12 illustrates a schematic representation of a perspective view of the mold 60.

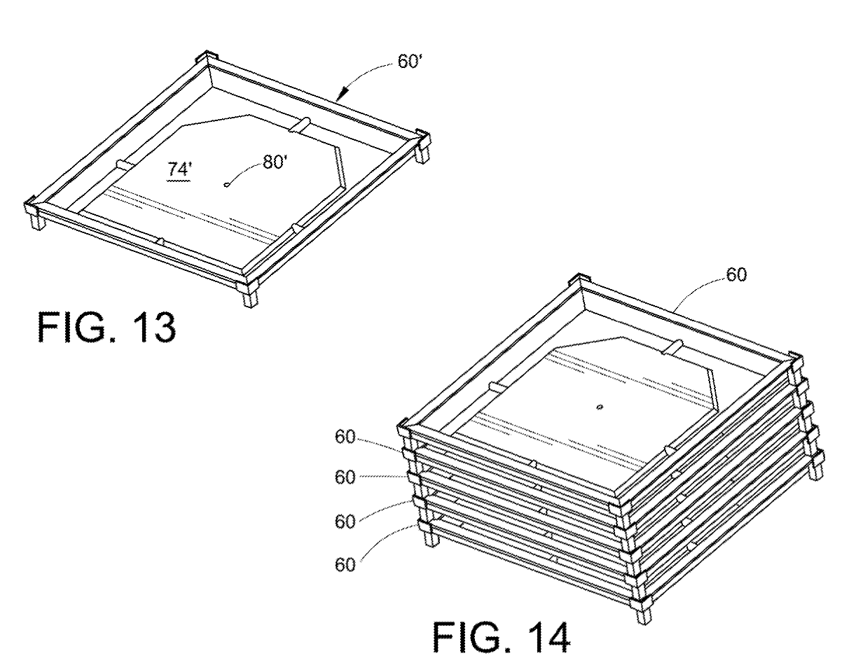

With reference to FIGS. 6-12, the mold 60 includes raised channel templates 72 for forming the channels 36 (see FIGS. 1-5). The mold 60 also includes a raised inset template 74 for forming the inset 30 (see FIGS. 1-5). Optionally, the inset template 74 is secured in the mold via fasteners 78. Alternatively, with reference to FIG. 13, an alternate embodiment is illustrated. For ease of understanding this embodiment of the present invention, like components are designated by like numerals with a primed (′) suffix and new components are designated by new numerals. With reference to FIG. 13, the inset template 74′ is integrally formed with the mold 60′.

With reference again to FIGS. 6-12, an orifice 80 is optionally included in the mold 60. Optionally, a raised insert 82 is secured in the orifice 80 in the mold 60. In one embodiment, the insert 82 is a cylinder (e.g., a ⅝″ sleeve); however, other shapes are also contemplated. For example, in one embodiment, as best seen in FIG. 11, the insert 82 is inserted into the orifice 80 from the bottom of the mold 60. A removable handle 84 prevents the insert 82 from being inserted too far into and/or passing out the other side of the orifice 80. Once the cylinder 82 is inserted in the orifice 80, a plug 86 is optionally inserted into the top portion of the insert 82 to prevent the pad material from entering (and setting inside) the insert 82. The pad material (e.g., concrete, plasticized concrete (e.g., precast concrete or plasticized concrete), recycled tires, Quazite, and/or plastic for example, possibly reinforced with steel wire) is then introduced into the mold 60. It is contemplated that the insert 82 is set in the pad material (e.g., the pad 10 (see FIG. 5)) as the pad material hardens.

Once the pad material sets (e.g., hardens), the pad 10 (see FIG. 5) may be removed from the mold 60 after the handle 84 and plug 86 are removed from the insert 82. To assist in removing the pad 10 (see FIG. 5) from the mold 60, it is contemplated that an inner wall of the insert 82 is threaded to threadedly engage a lifting mechanism 90 (see FIG. 5) that may be removably secured (e.g., screwed) into the insert 82. Once the lifting mechanism 90 is secured in the insert 82, the pad 10 may be lifted from the mold 60. The lifting mechanism 90 may be removed from the pad 10. Optionally, the lifting mechanism 90 may be retained for future use. More specifically, the lifting mechanism 90 may be removably secured again to the pad 10 in the future if it desired to move the pad 10 from one location to another. Therefore, the pad 10 is portable.

In one embodiment, once the pad 10 is properly positioned (e.g., at the curb 16 (see FIG. 1)), both the plug and the lifting mechanism 90 have previously been removed from the insert 82. Therefore, the orifice 80 is open and provides a passage from the top of the pad 10 to the bottom of the pad 10. The open orifice 80 acts as a drain means for draining liquid (e.g., water) from the inset 30 of the pad 10. The channels 36 (see FIGS. 1-5) also act as a drain means for draining liquid (e.g., water) from the inset 30 of the pad 10. Draining liquid from the inset 30 of the pad 10 helps reduce build-up of dirt and ice that may otherwise accumulate because of the moisture in the inset 30 of the pad 10.

Alternatively, if the insert 82 is not inserted into the orifice 80, the orifice 80 may simply be plugged. If the orifice 80 is plugged, it is contemplated that the pad 10, after being set, is removed from the mold 60 by tipping the mold 60 until gravity causes the pad 10 to move out of the mold 60. The plug is then removed before use to provide for drainage through the orifice 80 and the channels 36 as discussed above.

Although only a single pad 10 and mold 60 are illustrated, it is to be understood that multiple (e.g., double) molds and multiple (e.g., double) pads are also contemplated (see FIG. 1).

With reference to FIG. 14, it is also contemplated that the molds 60 are stackable.

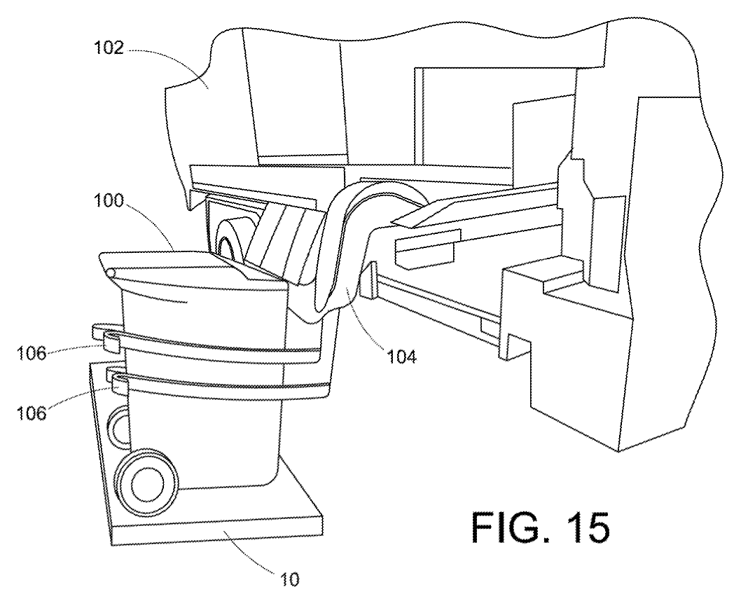

FIG. 15 illustrate a container 100 interacting with an arm 104 of a truck 102. In this embodiment, the arm 104 of the truck 102 includes extensions 106 that at least partially wrap around the container 100 (see FIG. 15). The arm 104 then lifts the container 100 to empty the container 100 into the truck 102. After the container 100 is emptied, the arm 104 replaces the container 100 in the recess of the pad 10 on the ground.

With reference to FIGS. 1-13, in one embodiment, the can 12 is about 4′ tall and weights about 27 lbs. when empty. As discussed above, once the container 12 is properly positioned in the recessed portion 30, cross-winds up to about 43 mph may cause the container 12 to slidably move within the recessed portion 30 (e.g., the bottom surface 34 of the container 12 will slide across the pad 10 in the recessed portion 30). However, the lip 35 defined at an edge of the recessed portion 30 will engage a side of the container 12 to prevent the container from both tipping and moving outside of the recessed portion 30.

While the present invention has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicant's general inventive concept.

I/we claim:

1. A pad, comprising:
a pad top surface;
a pad bottom surface; and
an inset defined in the pad top surface, the inset being sized and shaped for accommodating a can, and a depth of the inset relative to the pad top surface being defined for allowing a can bottom surface to be seated in the inset and below the pad top surface for resisting the can from tipping, when empty, in cross-winds up to about 43 mph.

2. The pad as set forth in claim 1, wherein:
the inset is recessed between about ¼″ to about 3″ relative to the pad top surface.

3. The pad as set forth in claim 1, wherein:
the can is between about 3′ high and about 4′ high; and
the inset is recessed to a sufficient depth to reduce a probability of the can, when empty, from tipping in the cross-winds.

4. The pad as set forth in claim 1, wherein:
the can is between about 3′ high and about 4′ high;
a footprint of the inset is sized larger than a footprint of the can bottom surface; and
the inset defines a lip that engages and contains the can, when empty, in the inset in the cross-winds.

5. The pad as set forth in claim 4, wherein:
the footprint of the inset is sized to permit the can bottom surface to slidably move in the inset in the cross-winds.

6. The pad as set forth in claim 1, wherein:
the inset is about 28″ by about 23.5″.

7. The pad as set forth in claim 1, further including:
a channel for permitting drainage from the inset.

8. The pad as set forth in claim 1, further including:
means for permitting drainage from the inset.

9. The pad as set forth in claim 1, further including:
an orifice for receiving a lifting mechanism for facilitating lifting of the pad.

10. The pad as set forth in claim 9, further including:
a sleeve in the orifice;
wherein an inner wall of the sleeve is threaded for threadedly engaging the lifting mechanism.

11. The pad as set forth in claim 1, wherein:
the pad top surface receives a pad bottom surface of a second pad for stacking

12. A system for retaining a can on a pad, the system comprising:
a can;
a pad, including:
a pad top surface;
a pad bottom surface; and
an recessed portion defined in the pad top surface, the recessed portion being sized and shaped for accommodating the can, and a depth of the recessed portion relative to the pad top surface being defined for allowing a can bottom surface to be seated in the inset and below the pad top surface for resisting the can from tipping, when empty, in cross-winds up to about 43 mph.

13. The system for retaining a can on a pad as set forth in claim 12, wherein:
the can is about at least 3′ tall;
the recessed portion is recessed between about ¼″ to about 3″ relative to the pad top surface; and
a lip defined by the recessed portion retaining the can in the recessed portion in the cross-winds.

14. The system for retaining a can on a pad as set forth in claim 13, wherein:
the lip defined by the recessed portion reducing a probability that the can will tip, when empty, in the cross-winds.

15. The system for retaining a can on a pad as set forth in claim 12, wherein:
the recessed portion is recessed between about ¼″ to about 3″ relative to the pad top surface.

16. The system for retaining a can on a pad as set forth in claim 12, further including:
a channel for permitting drainage from the inset.

17. A trash collection system, the system comprising:
a can;
a pad, including:
a pad top surface;
a pad bottom surface; and
an recessed portion defined in the pad top surface, the recessed portion being sized and shaped for accommodating the can, and a depth of the recessed portion relative to the pad top surface being defined for allowing a can bottom surface to be seated in the inset and below the pad top surface; and
a truck including an arm for retrieving the can from, and replacing the can to, the recessed portion, the can, when empty, remaining upright when positioned in the recessed portion even in winds up to about 43 mph.

18. The trash collection system as set forth in claim 17, wherein:
the can is about at least 3′ tall;
the recessed portion is recessed between about ¼″ to about 3″ relative to the pad top surface; and
a lip defined by the recessed portion retains the can in the recessed portion in the winds up to about 43 mph.

19. The trash collection system as set forth in claim 17, wherein the pad further includes:
a channel for permitting drainage from the inset.
